(19) United States
(12) Patent Application Publication
(10) Pub. No.: US 2018/0204289 A1
(43) Pub. Date: Jul. 19, 2018

(54) Computer-Implemented Method, Computer Program Product and System for Facilitating Remote Transfer of Financial Information and File Creation

(71) Applicant: Isaac Bundy, Salt Lake City, UT (US)

(72) Inventor: Isaac Bundy, Salt Lake City, UT (US)

(21) Appl. No.: 15/408,021

(22) Filed: Jan. 17, 2017

(51) Int. Cl. G06Q 40/00

(52) U.S. Cl. CPC G06Q 40/123

(57) ABSTRACT

A computer program product, system, and computer-implemented method for facilitating remote transfer of financial information between a user and a technology provider. The method includes creation of a list file in a DBMS containing needed financial documents, writing personal information into computer-readable memory, and accepting into computer readable memory a plurality of Booleans, each Boolean exclusively associated with a needed document.

### BACKGROUND OF THE INVENTION

### Field of the Invention

This invention relates generally to data processing systems implemented on computers, and more specifically relates to data processing systems for aggregating tax-related information and integrating the same into one or more computer-readable files.

### Description of the Related Art

Enterprise software systems may comprise numerous modules, distributed across many different hardware platforms, often in separated geographical locations. The architecture of a large software application is an important aspect of its design for a successful implementation. A web service is a standards-based way of encapsulating the functionality of an application that other applications can locate and access. A service-oriented architecture is a distributed software model within which functionality is defined as independent web services. Within a service-oriented architecture, web services can be used in defined sequences according to business logic to form applications that enable business processes.

This specification describes a services architecture design that provides enterprise services having accounting and tax preparation functionality at the level of an enterprise application.

In its various aspects, the invention can be embodied in systems, methods, and computer program products. For example, a system in one embodiment implements a services architecture design that provides enterprise services having accounting and tax remission functionality. The design includes a set of service operations, process components, and optionally deployment units. Suitable business objects are also described.

There exist many computer applications in the art for retrospective allocation of expenditures as personal expenses, tax deductible expenses, and the like. In most of these applications, manual classification of individual expenses is required, including programs such as QuickBooks®, Excel®, TurboTax® and Quicken®. There exist no programs, systems or methods for efficiently requesting and compiling financial information for tax purposes from individuals.

Many individuals, businesses, spouses, and consumers are dissuaded from using the financial services of a professional accountant because of the difficulty in aggregating and transmitting the tax information to the account and/or meeting with the accountant. These individuals and organizations have no access to efficient means in the art of simply and efficiently remitting information necessary for taxes and tax return to be assembled.

A system, method and computer program product are needed for facilitating efficient collection and transfer of tax information to an accounting organization.

### SUMMARY OF THE INVENTION

From the foregoing discussion, it should be apparent that a need exists for a computer program product (CPP), method and system for facilitating remote transfer of financial information and file creation. Beneficially, such a CPP, system and method would allow individuals and organizations to efficiently aggregate and transfer financial and tax information to a technology provider.

The present invention has been developed in response to the problems and needs in the art that have not yet been fully solved by currently available, CPPs apparati and methods. Accordingly, the present invention has been developed to provide a computer-implemented method for facilitating remote transfer of financial information, the steps of the method comprising: accepting into computer-readable memory on a signal bearing medium personal information of a user, the personal information comprising: a name, an address, a telephone number, an email address, and one of a social security number (SSN) and an employer identification number (EIN); accepting into computer-readable memory an acceptance from a user of the terms of an agreement displayed online containing legal terms binding upon the user and a technology provider; accepting into computer-readable memory an acceptance from a user to a plurality of yes or no questions, each acceptance comprising tactile input on a touch screen from a user in the form a sliding motion to the left side of a touch screen, wherein the acceptance is accepted by enqueuing a Boolean in a document queue in computer-readable memory; accepting into computer-readable memory a plurality of rejections from a user to a plurality of yes or no questions, each rejection comprising tactile input on a touch screen from a user in the form a sliding motion to the right side of a touch screen, wherein the acceptance is accepted by enqueuing a Boolean in a document queue in the computer-readable memory; populating a list of financial documents by referencing Booleans in the document queue, each positive Boolean representing a corresponding needed document; displaying the list of financial documents to the user; requiring the user to upload digital photographs of each of the documents in the list of financial documents from a mobile DPD, wherein the photographs are created with an image sensor in the mobile DPD using a CPP offered by the technology provider; applying OCR to uploaded documents in the list of financial documents; and notifying the user that OCR application has failed in response to failure of OCR application.

The method may further comprise deleting the digital photographs from computer-readable memory on the user's DPD in response to OCR success. The method may further comprise accepting a data type into computer-readable memory from the user representing a color scheme for use in a browser.

In some embodiments, the method further comprises accepting a variable into computer-readable memory from the user indicative of a unique identifier exclusively associated with an accounting organization.

The method may further comprise facilitating real-time textual communication between the user and the technology provider. In some embodiments, the method further comprises creating a computer-readable DMBS file comprising the digital photographs, the Booleans, and the variable.

A system for brokering a real world transaction is also provided, the system comprising: a plurality of processors; persistent computer-readable memory; an identifier module configured to accept into computer-readable memory on a signal bearing medium personal information of a user, the personal information comprising: a name, an address, a telephone number, an email address, and one of a social security number (SSN) and an employer identification number (EIN); an acceptor module configured to accept into computer-readable memory an acceptance from a user of the terms of an agreement displayed online containing legal terms binding upon the user and a technology provider; a questioner module configured to: accept into computer-readable memory an acceptance from a user to a plurality of yes or no questions, each acceptance comprising tactile input on a touch screen from a user in the form a sliding motion to the left side of a touch screen, wherein the acceptance is accepted by enqueuing a Boolean in a document queue in computer-readable memory; and accept into computer-readable memory a plurality of rejections from a user to a plurality of yes or no questions, each rejection comprising tactile input on a touch screen from a user in the form a sliding motion to the right side of a touch screen, wherein the acceptance is accepted by enqueuing a Boolean in a document queue in the computer-readable memory; a populator module configured to populate a list of financial documents by referencing Booleans in the document queue, each positive Boolean representing a corresponding needed document; a display module configured to display the list of financial documents to the user; a photographer module configured to created with an image sensor a plurality of digital photographs; a OCR module configured to apply OCR to uploaded documents in the list of financial documents; and a notification module configured to notify the user that OCR application has failed in response to failure of OCR application.

Each of the modules may be embodied by computer usable program code coded in the form on an object imparting function to each of the modules.

The system may further comprise a delete module configured to delete the digital photographs from computer-readable memory on the user's DPD in response to OCR success.

The system may further comprise a texter module configured to facilitate real-time textual communication between the user and the technology provider.

A computer program product is provided comprising a computer readable medium having computer usable program code executable to perform operations for facilitating remote transfer of financial information, the operations of the computer program product comprising: accepting into computer-readable memory on a signal bearing medium personal information of a user, the personal information comprising: a name, an address, a telephone number, an email address, and one of a social security number (SSN) and an employer identification number (EIN); accepting into computer-readable memory an acceptance from a user of the terms of an agreement displayed online containing legal terms binding upon the user and a technology provider; accepting into computer-readable memory an acceptance from a user to a plurality of yes or no questions, each acceptance comprising tactile input on a touch screen from a user in the form a sliding motion to the left side of a touch screen, wherein the acceptance is accepted by enqueuing a Boolean in a document queue in computer-readable memory; accepting into computer-readable memory a plurality of rejections from a user to a plurality of yes or no questions, each rejection comprising tactile input on a touch screen from a user in the form a sliding motion to the right side of a touch screen, wherein the acceptance is accepted by enqueuing a Boolean in a document queue in the computer-readable memory; populating a list of financial documents by referencing Booleans in the document queue, each positive Boolean representing a corresponding needed document; displaying the list of financial documents to the user; requiring the user to upload digital photographs of each of the documents in the list of financial documents from a mobile DPD, wherein the photographs are created with an image sensor in the mobile DPD using a CPP offered by the technology provider; applying OCR to uploaded documents in the list of financial documents; and notifying the user that OCR application has failed in response to failure of OCR application.

The computer-program product may further comprise deleting the digital photographs from computer-readable memory on the user's DPD in response to OCR success.

In some embodiments, the computer-program product further comprises accepting a data type into computer-readable memory from the user representing a color scheme for use in a browser.

The computer-program may further comprise accepting a variable into computer-readable memory from the user indicative of a unique identifier exclusively associated with an accounting organization.

The computer-program product may further comprise facilitating real-time textual communication between the user and the technology provider. The computer-program product may also further comprise creating a computer-readable DMBS preparation file comprising the digital photographs, the Booleans, and the variable.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is block diagram of a system for facilitating remote transfer of financial information and file creation in accordance with an embodiment of the present invention;

FIG. 2A is flow chart of a method for facilitating remote transfer of financial information and file creation used by the system of FIG. 1 in accordance with the present invention;

FIG. 2B is flow chart of a method for facilitating remote transfer of financial information and file creation used by the system of FIG. 1 in accordance with the present invention;

FIG. 3 is user interface displayed on a browser in accordance with the present invention;

FIG. 4 is user interface displayed on a browser in accordance with the present invention;

FIG. 5 is user interface displayed on a browser in accordance with the present invention;

FIG. 6 is an entity-relationship diagram illustrating data flow between entities in accordance with the present invention;

FIG. 7 is a block diagram illustrating modules of a system in accordance with the present invention;

FIG. 8 is a data layout diagram illustrating aggregated financial data from a user in accordance with the present invention; and

FIG. 9 is a data layout diagram illustrating one embodiment of a tax data file in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are given to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The embodiments of the present invention described herein generally provide for a system, computer program product, and a method for using an online network to facilitate remote transfer of tax and financial information. Those individuals and entities desiring or needing tax or financial services are referred to herein as consumers or users and these terms are used synonymously throughout this specification. Similarly individuals or organizations who are willing to provide the desired financial or tax services are herein referred to as the technology providers. Reference to users or technology providers may include a tablet computer, smartphone, or DPD (data processing device) under the control of the user or technology provider. Additionally, the community described herein may be referred to as a network, group, friends, or family and these terms are synonymous as used throughout this specification. The technology provider may be a DPD or system of DPDs, including server(s), operating independently of the consumers and providers, configured to facilitate the receipt, maintenance and provision of information between the consumers and providers.

Hence, in general terms, the present invention provides for CPP, system or method.

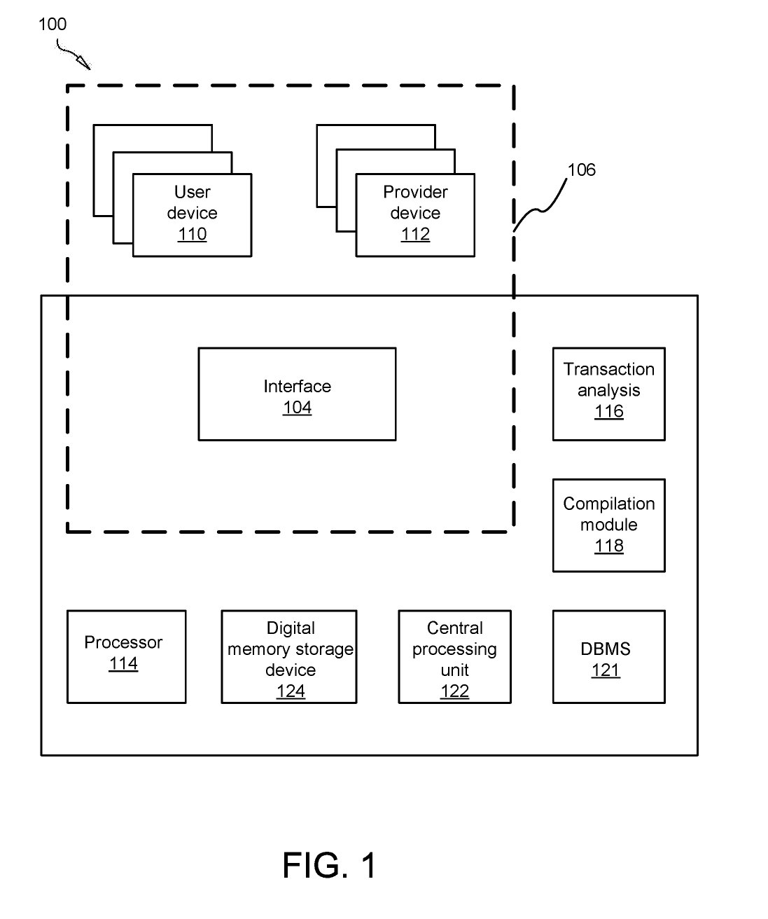

Accordingly, as illustrated in FIG. 1, a system, indicated generally at 100, is shown in accordance with an embodiment of the present invention for facilitating remote transfer of financial information. The system 100 is shown and described broadly in FIG. 1. The system 100 can receive real time data from users and can analyze the data along with previously stored data.

The system 100 can include an interface, indicated generally at 104, for interacting with requester and provider devices, indicated generally at 110 and 112, respectively. In one aspect the interface 104 can include a network, indicated generally at 106, that can be established between the requester and provider devices 110 and 112.

The system 100 can also include a processor, indicated generally at 114, that can receive, process, analyze, manipulate, store, and transmit data between the requester and provider devices 110 and 112. For example, the processor 114 can include a transaction analysis module, indicated generally at 116, that can receive request data for goods and services from a user device 110 and can compare and analyze data from a user. The processor 114 can also have a compilation module, indicated generally at 118, that can store and process financial data. Additionally, the system can have a DBMS 121, which is well-known to those of skill in the art.

The system 100 may include one or more processors 114 that execute instructions on a computer-readable medium, such as a central processing unit, indicated generally at 122, or digital memory storage device 124, that cause the one or more processors 114 to make a determinations and evaluation of computer data.

In one aspect, the system 100 can also include a plurality of mobile computing devices, such as user devices 110 and provider devices 112.

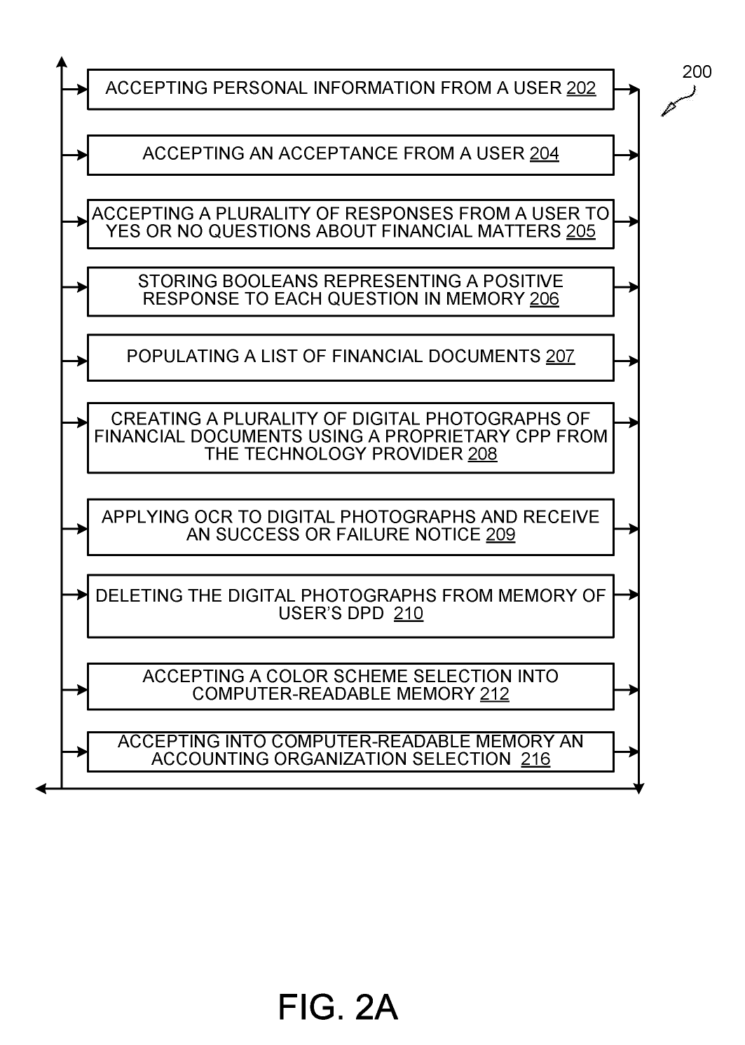

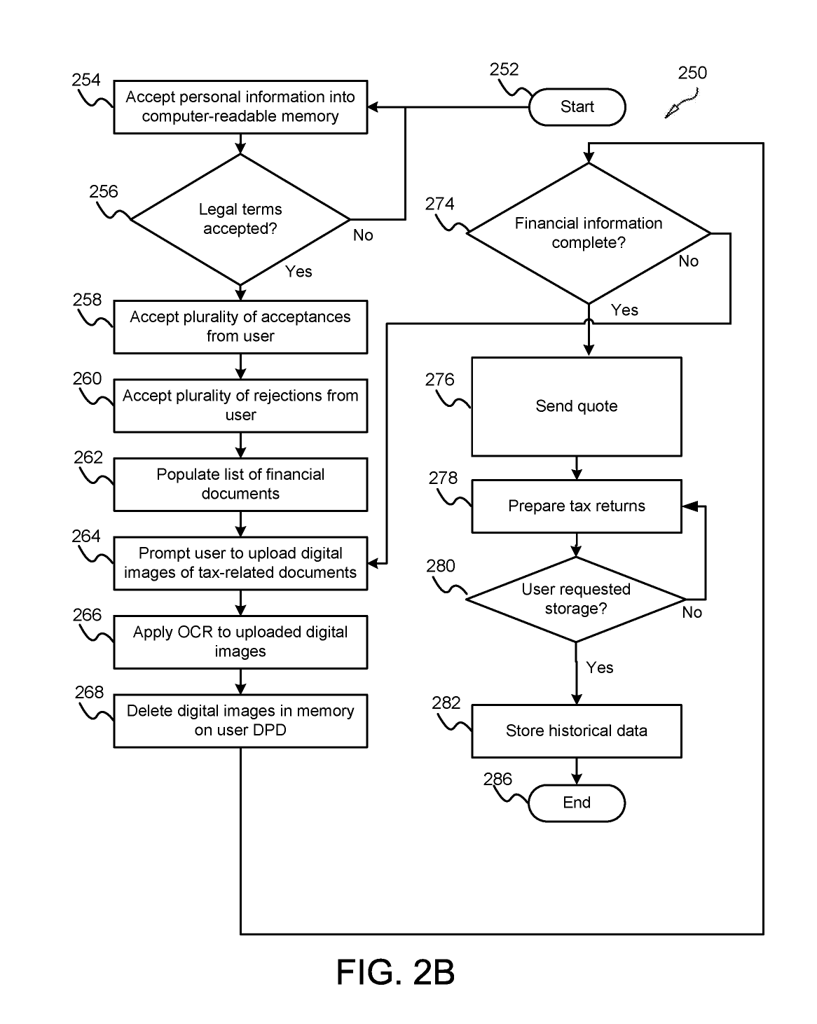

FIG. 2A is flow chart of a method 200 for facilitating remote transfer of financial information and file creation used by the system of FIG. 1 in accordance with the present invention.

The method 200 begins when personal information is accepted 202 from a user, including name, social security number, email, address, and telephone number. The user must upload an acceptance in the form of a Boolean evaluating as true for an acceptance of a terms and conditions and privacy policy which is accepted 204 into computer readable memory.

The technology provider prompts the user to answer a plurality of predetermined true or false questions, responses to which are accepted 205 into computer readable memory. These responses are stored 206 as Booleans evaluating as true or false indicative of the user's responses. Examples of questions to which the user is prompted to response include: (a) Do you claim any dependents? (b) Do you own a home? (c) Did you derive 1099 revenue? (d) Did you derive W-2 revenue? (e) Are you married? (f) Are you married and filing jointly? (f) Are you married and filing separately, and the like.

A list of financial documents which the user must copy digitally and upload is populated 207 in response to Booleans evaluating as true or false which are representative of the user's responses.

The user is prompted to upload each of the documents in the list. These documents may be saved as part of a single computer-readable file or as separate computer-readable files in a relational database management system (RDBMS). Each of the documents is subjected/applied 209 to an optical character recognition (OCR) process to textualize information in the document. Financial information is drawn from the textualized information in the document including numerals. These numerals are transmitted over a signal bearing medium to a third-party tax preparer incorporated with the technology provider selected by the user from a list of predetermined tax preparers who enter the numerals into fields in a tax form.

After tax information is uploaded to the Internal Revenue Service (IRS) and one or more state authorities, the copies of the financial documents stored in computer-readable memory by the technology provider are deleted 210.

The user may change the color scheme of the application, and select which tax preparation organization the user would like financial information forwarded to.

FIG. 2B is flow chart of a method for facilitating remote transfer of financial information and file creation used by the system of FIG. 1 in accordance with the present invention.

Personal information is accepted 254 or received into computer-readable memory over a signal bearing medium. The consumer request is further described below, but comprises a computer file, or a series of computer files, identifying a user willing to contract for tax preparation services.

In various embodiments, the CPP, system, or method performs a check 256 to determine whether or not various terms and conditions have been satisfied. If the user has accepted the terms and conditions and privacy policy, the method 250 progresses and a plurality of responses to yes or no questions are stored in computer-readable memory. Acceptances are accepted 258 into computer-readable memory and rejections are accepted 260 into computer-readable memory.

These acceptance may be transmitted from a wireless DPD over a WAN (wide area network) (and may comprise a simple variable such as a Boolean evaluated as true if the provider has accepted) to a computer-readable file in a DBMS with parameters or conditions of the provider acceptance.

The acceptance is forwarded 264 from computer-readable memory to the technology provider. The technology provider populates a list of needed documents and prompts 262 the user to upload these documents into computer-readable memory. Once uploaded, each document is automatically scanned using OCR technology applied 266 to the document. Once financial data has been extracted from the documents, the digital copies of the documents in computer-readable memory on the side of the technology providers are deleted 268.

If 274 all of the documents in the list populated by the technology provider have been uploaded by the user, third party tax preparers are sent summaries of the documents and asked to create a quote. The quotes are aggregated by the technology provider into a queue or list and sent 276 to user. The tax preparer selected by the user prepares 278 the tax returns for the user and files them electronically.

If 280 the user requests storage of the documents, the tax preparer stores 282 the digitally-uploaded documents and stores 286 historical data about the user and tax returns.

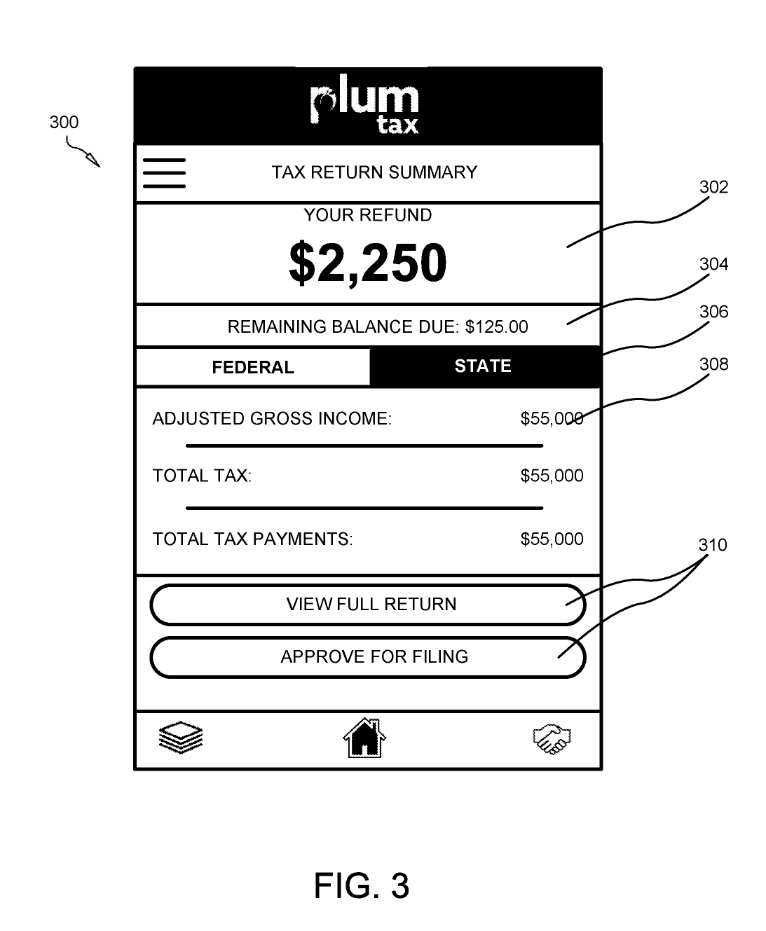

FIG. 3 is user interface displayed on a browser 300 in accordance with the present invention. FIG. 3 shows one embodiment of an application page, indicated generally at 300, on which a user can select from many options, indicated generally at 320, to navigate around the system interface.

A user is shown the amount 302 which will be refunded after upload of financial documents and application of OCR. The balance due 304 to the technology provider is shown as well as whether data from state or federal taxes is being shown. Adjusted gross income 308 is displayed in the browser 300 and virtual controls 310 are provided for allowing a user to view the prepared tax returns and submit the taxes for filing.

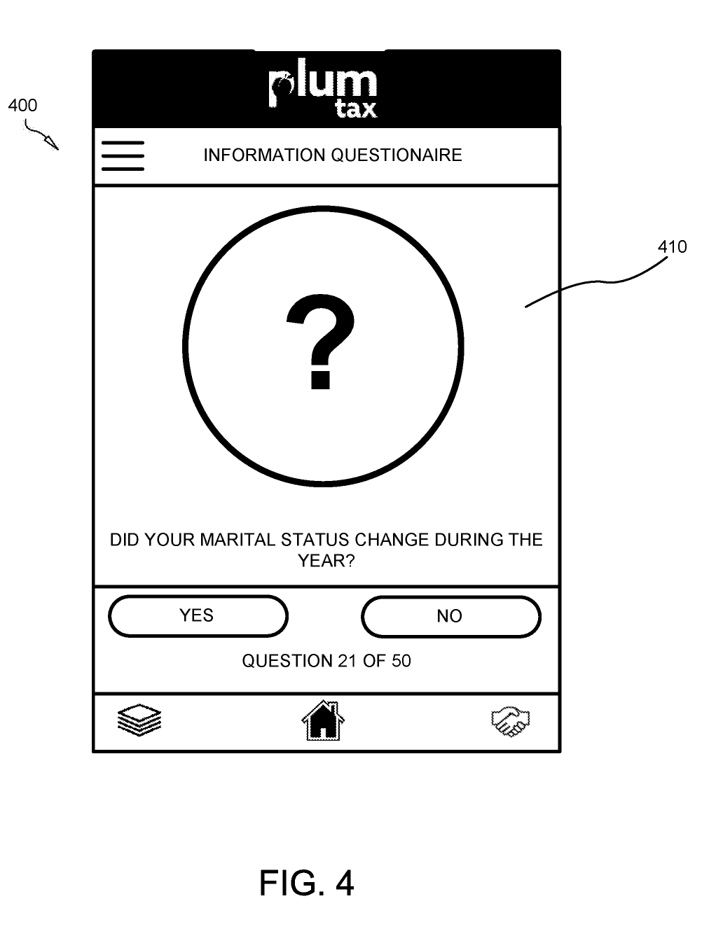

FIG. 4 is user interface 400 displayed on a browser in accordance with the present invention. The user is prompted to respond to a plurality of yes or no questions 410 which are displayed via the interface 400 in the browser as shown, using a large question mark.

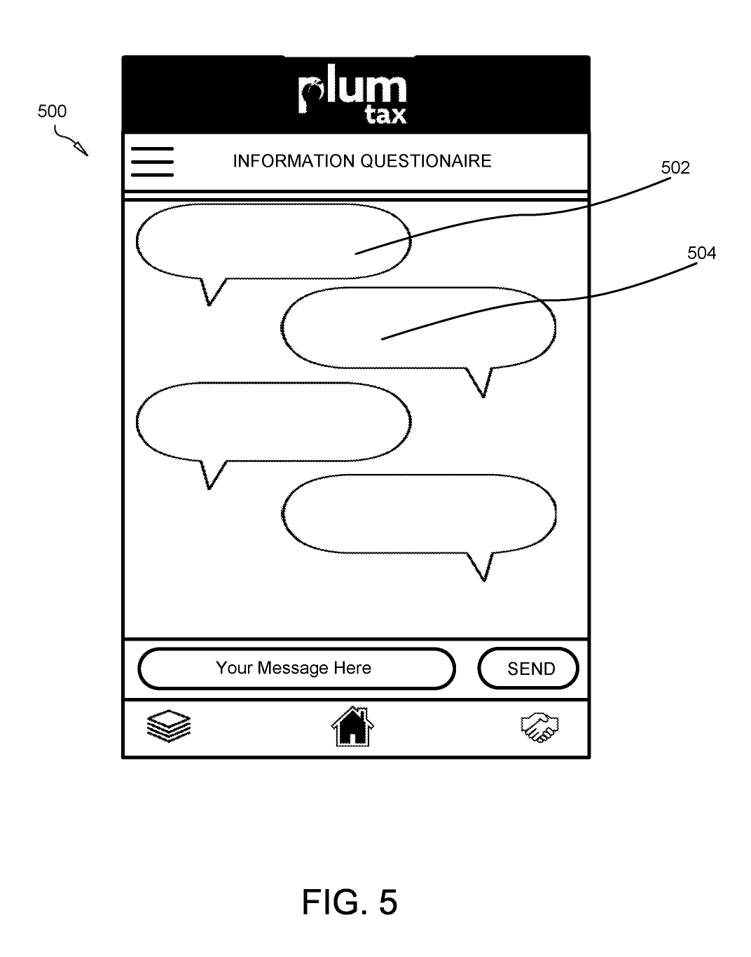

FIG. 5 is user interface displayed on a browser in accordance with the present invention.

In some embodiments, textual communication is facilitated between a tax preparer, technology provider and/or the user. A message 502 from the tax preparer is stored in historical data, as is a message from the user 504.

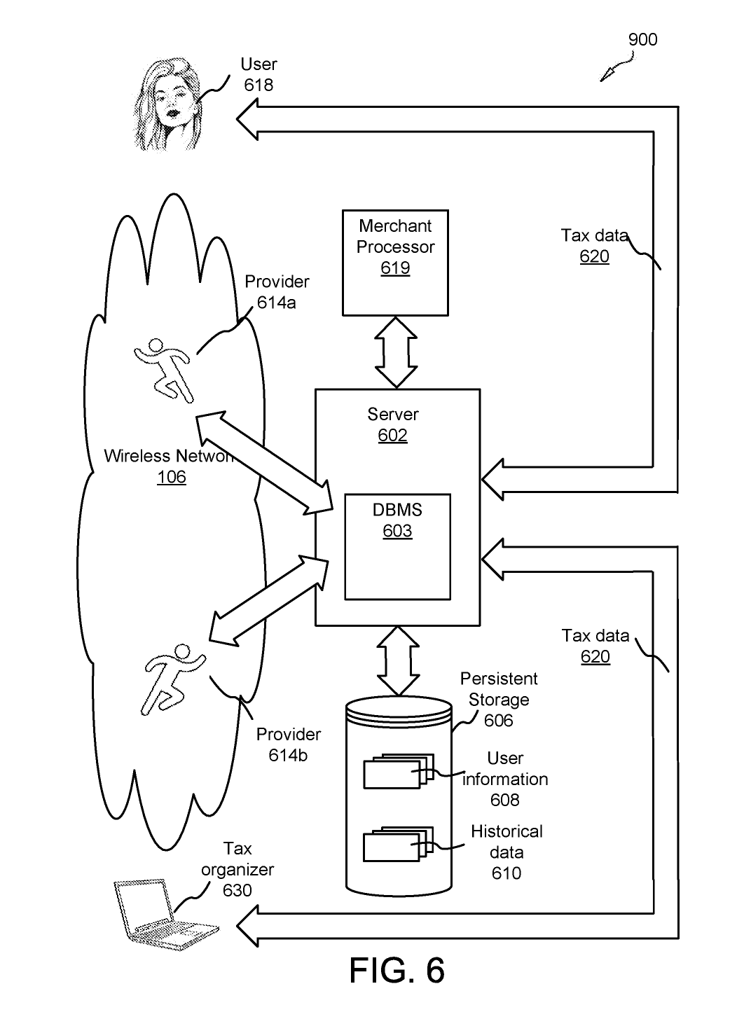

FIG. 6 is an entity-relationship diagram illustrating data flow between entities in accordance with a system 600 embodiment of the present invention.

The system 600 comprises a server 602, a database management system (DBMS) 603, persistent storage 606 having provider information 608 and historical data 610, a wireless network 106, a user 618, a tax organizer 630, a merchant processor 619, tax data 620.

Typically, the server 602 comprises one or more central processing units executing software and/or firmware to control and manage the other components within the system 600. In one embodiment, the server 602 comprises hardware and/or software more commonly referred to as a Multiple Virtual Storage (MVS), OS/390, zSeries/Operating System (z/OS), UNIX, Linux, or Windows.

The server 602 may comprise a server cluster with firewalls, load balancer, and database servers having Apache® and/or other software applications well-known to those of skill in the art. The server 602, in the shown embodiment, comprises a database management system (DBMS) 603 or relational database management system (RDBMS), such as Oracle, MySQL, SQL, FireBird, IBM DB2®, or the like.

The server 602 is in logical communication with one or more users 618 and one or more tax organizers 630 through a networked environment such as local area network (LAN) or wide area network (WAN). The server 602 may communicate with users 618 and/or tax organizers 630, sending tax data 620 using variations of the Simple Mail Transfer Protocol (SMTP), Internet Message Access Protocol (IMAP), Post Office Protocol (POP), or other protocols well-known to those of skill in the art.

The user 618 and the tax organizer may comprise a smartphone.

In the present invention, the server 602 routes information between users 618 and tax organizers 630. The server 902 is in logical communication via the Internet 106 with the cellular phones of users 618, or through other personal DPDs such as laptops, digital cameras, and the like.

In the present invention, as further described in detail above and below, users 618 create a tax data file which is then relayed to the server 602. This tax data 620 comprises personal financial information of the user 618, including images of W-2s, 1099s, social security numbers and the like.

The user 618 may comprise any person, company, or organization that is potentially a tax payer. Each user 618 is incorporated into a network comprising individuals, tax organizers 630 and entities who have registered with the server 602. For the purposes of this patent, the terms “incorporate” and “incorporation” denote the act of formally enrolling a tax organizer 630 or user 618 into the marketing network.

Tax organizers 630 and users 618 become incorporated when they create accounts with the server 602 by uploading personal identifying information, including one or more of: an address, an email address, a telephone number, and the like. In typical embodiments, the registration takes place via a browser, but may also be sent to the server 602 using programs well-known to those of skill in the art, such as Microsoft Outlook, Thunderbird, Yahoo! Mail, and the like.

The system 600 may comprise any sub-system, apparatus, or computer program running on one or more data processing devices (DPDs), such as a server, computer workstation, router, mainframe computer, or the like. In various embodiments, the DPD comprises one or more processors. The processor is a computing device well-known to those in the art and may include an application-specific integrated circuit (“ASIC”).

Tax data 620 is stored in persistent storage 606.

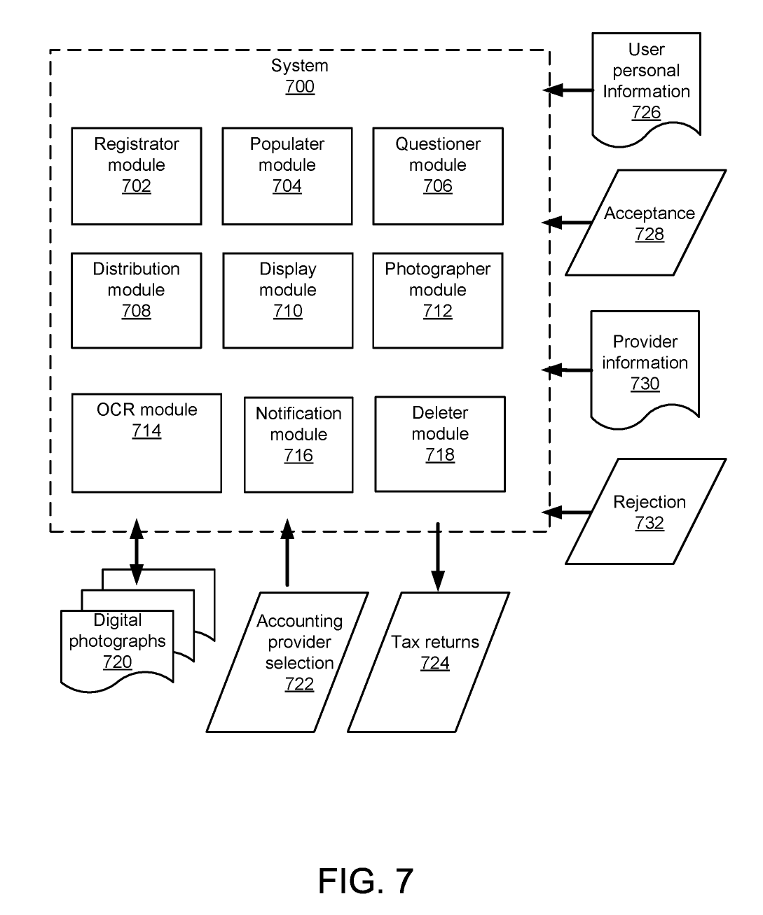

FIG. 7 is a block diagram illustrating modules of a system 700 in accordance with the present invention. The system 700 comprises a registrator module, a populator module, a questioner module, a distribution module, a display module 710, a photographer module 712, an OCR module, a notification module, a delete module 718, digital photograph 720, an accounting provider selection 722, tax returns 724, user personal information 726, acceptance 728, provider information 730, and a rejection 732.

The registrator module 702 incorporates or registers users and tax preparers with the technology provider as described in relation to FIGS. 1-6 above. Personal information of a user 726 is sent in a computer-readable file to the system 700, as is the information of each tax preparer (i.e. provider) bidding on jobs.

The populator module 704 populates a list of required documents in response to yes or no questions relayed to a user by the questioner module 706 and displays using the display module 710 the list to a user via a browser.

The distribution module 708 relays tax information extracted using the OCR module 714 to tax preparers incorporated with the technology provider.

The photographer module 712 photographs financial documents on the DPD of a user and converts them into digital photographs 720, and the delete module 718 deletes digital files after filing of tax returns 724.

The user's selection of an accounting provider 722 is sent to the system 700 from a user's DPD. A user rejection 732 of a tax preparer or question is also relayed via a WAN to the technology provider.

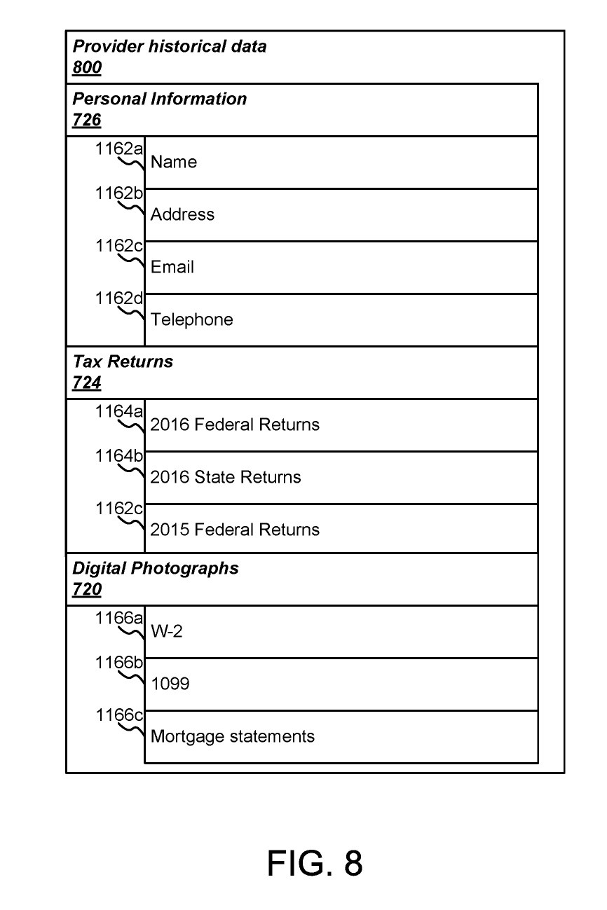

FIG. 8 is a data layout diagram illustrating aggregated financial data from a user compiled in a single computer-readable file in accordance with the present invention. Historical data 800 for each provider (or tax preparer) is stored in computer-readable memory including personal information 726, tax returns 724, and digital photographs 720.

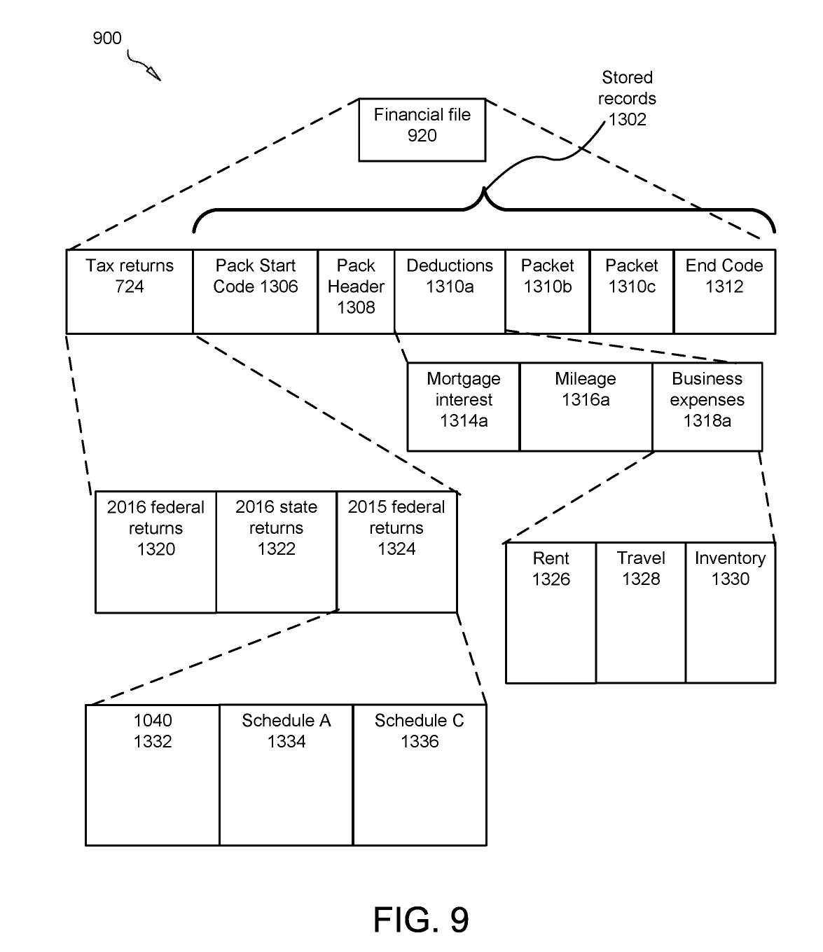

FIG. 9 is a data layout diagram illustrating one embodiment of a tax data file in accordance with the present invention.

In various embodiments, all of the documents received and generated from a user are stored in a single computer-readable file as shown. Tax returns 724 may comprise federal tax returns 1320, and state returns 1322. Business expenses 1318 may be broken down as shown.

The digital photographs 720 relayed by the user may comprise images and/or video and/or audio, including files in JPG, WAV, MP4 and other formats known to those of skill in the art.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer-implemented method for facilitating remote transfer of financial information, the steps of the method comprising:
accepting into computer-readable memory on a signal bearing medium personal information of a user, the personal information comprising: a name, an address, a telephone number, an email address, and one of a social security number (SSN) and an employer identification number (EIN);
accepting into computer-readable memory an acceptance from a user of the terms of an agreement displayed online containing legal terms binding upon the user and a technology provider;
accepting into computer-readable memory an acceptance from a user to a plurality of yes or no questions, each acceptance comprising tactile input on a touch screen from a user in the form a sliding motion to the left side of a touch screen, wherein the acceptance is accepted by enqueuing a Boolean in a document queue in computer-readable memory;
accepting into computer-readable memory a plurality of rejections from a user to a plurality of yes or no questions, each rejection comprising tactile input on a touch screen from a user in the form a sliding motion to the right side of a touch screen, wherein the acceptance is accepted by enqueuing a Boolean in a document queue in the computer-readable memory;
populating a list of financial documents by referencing Booleans in the document queue, each positive Boolean representing a corresponding needed document;
displaying the list of financial documents to the user;
requiring the user to upload digital photographs of each of the documents in the list of financial documents from a mobile DPD, wherein the photographs are created with an image sensor in the mobile DPD using a CPP offered by the technology provider;
applying OCR to uploaded documents in the list of financial documents; and
notifying the user that OCR application has failed in response to failure of OCR application.

2. The method of claim 1, further comprising deleting the digital photographs from computer-readable memory on the user's DPD in response to OCR success.

3. The method of claim 1, further comprising accepting a data type into computer-readable memory from the user representing a color scheme for use in a browser.

4. The method of claim 1, further comprising accepting a variable into computer-readable memory from the user indicative of a unique identifier exclusively associated with an accounting organization.

5. The method of claim 1, further comprising facilitating real-time textual communication between the user and the technology provider.

6. The method of claim 4, further comprising creating a computer-readable DMBS financial file comprising the digital photographs, the Booleans, and the variable.

7. A system for brokering a real world transaction, the system comprising:
a plurality of processors;
persistent computer-readable memory;
an identifier module configured to accept into computer-readable memory on a signal bearing medium personal information of a user, the personal information comprising: a name, an address, a telephone number, an email address, and one of a social security number (SSN) and an employer identification number (EIN);
an acceptor module configured to accept into computer-readable memory an acceptance from a user of the terms of an agreement displayed online containing legal terms binding upon the user and a technology provider;
a questioner module configured to:
accept into computer-readable memory an acceptance from a user to a plurality of yes or no questions, each acceptance comprising tactile input on a touch screen from a user in the form a sliding motion to the left side of a touch screen, wherein the acceptance is accepted by enqueuing a Boolean in a document queue in computer-readable memory; and
accept into computer-readable memory a plurality of rejections from a user to a plurality of yes or no questions, each rejection comprising tactile input on a touch screen from a user in the form a sliding motion to the right side of a touch screen, wherein the acceptance is accepted by enqueuing a Boolean in a document queue in the computer-readable memory;
a populator module configured to populate a list of financial documents by referencing Booleans in the document queue, each positive Boolean representing a corresponding needed document;
a display module configured to display the list of financial documents to the user;
a photographer module configured to created with an image sensor a plurality of digital photographs;
a OCR module configured to apply OCR to uploaded documents in the list of financial documents; and
a notification module configured to notify the user that OCR application has failed in response to failure of OCR application.

8. The system of claim 7, wherein each of the modules is embodied by computer usable program code coded in the form on an object imparting function to each of the modules.

9. The system of claim 7, further comprising a delete module configured to delete the digital photographs from computer-readable memory on the user's DPD in response to OCR success.

10. The system of claim 7, further comprising a texter module configured to facilitate real-time textual communication between the user and the technology provider.

11. A computer program product comprising a computer readable medium having computer usable program code executable to perform operations for facilitating remote transfer of financial information, the operations of the computer program product comprising:
accepting into computer-readable memory on a signal bearing medium personal information of a user, the personal information comprising: a name, an address, a telephone number, an email address, and one of a social security number (SSN) and an employer identification number (EIN);
accepting into computer-readable memory an acceptance from a user of the terms of an agreement displayed online containing legal terms binding upon the user and a technology provider;
accepting into computer-readable memory an acceptance from a user to a plurality of yes or no questions, each acceptance comprising tactile input on a touch screen from a user in the form a sliding motion to the left side of a touch screen, wherein the acceptance is accepted by enqueuing a Boolean in a document queue in computer-readable memory;
accepting into computer-readable memory a plurality of rejections from a user to a plurality of yes or no questions, each rejection comprising tactile input on a touch screen from a user in the form a sliding motion to the right side of a touch screen, wherein the acceptance is accepted by enqueuing a Boolean in a document queue in the computer-readable memory;
populating a list of financial documents by referencing Booleans in the document queue, each positive Boolean representing a corresponding needed document;
displaying the list of financial documents to the user;
requiring the user to upload digital photographs of each of the documents in the list of financial documents from a mobile DPD, wherein the photographs are created with an image sensor in the mobile DPD using a CPP offered by the technology provider;
applying OCR to uploaded documents in the list of financial documents; and
notifying the user that OCR application has failed in response to failure of OCR application.

12. The computer-program product of claim 11, further comprising deleting the digital photographs from computer-readable memory on the user's DPD in response to OCR success.

13. The computer-program product of claim 1, further comprising accepting a data type into computer-readable memory from the user representing a color scheme for use in a browser.

14. The computer-program product of claim 1, further comprising accepting a variable into computer-readable memory from the user indicative of a unique identifier exclusively associated with an accounting organization.

15. The computer-program product of claim 1, further comprising facilitating real-time textual communication between the user and the technology provider.

16. The computer-program product of claim 4, further comprising creating a computer-readable DMBS preparation file comprising the digital photographs, the Booleans, and the variable.
